(19) United States
(12) Patent Application Publication
(10) Pub. No.: US 2014/0210848 A1
(43) Pub. Date: Jul. 31, 2014

(54) IMAGE PROCESSING APPARATUS AND IMAGE DISPLAY SYSTEM

(71) Applicant: Fuji Xerox Co., Ltd., Tokyo (JP)

(72) Inventors: Toshihiro IWAFUCHI, Kanagawa (JP); Noriko SAKAI, Kanagawa (JP); Daigo HAMA, Kanagawa (JP)

(73) Assignee: Fuji Xerox Co., Ltd., Tokyo (JP)

(21) Appl. No.: 14/045,868

(22) Filed: Oct. 4, 2013

(30) Foreign Application Priority Data
Jan. 30, 2013 (JP) 2013-015573

(51) Int. Cl. G09G 5/02

(52) U.S. Cl. CPC G09G 5/02
USPC 345/593

(57) ABSTRACT

An image processing apparatus includes an acquisition unit, a memory, and a preparation unit. The acquisition unit acquires, from a display device that displays an image on a display screen, device information peculiar to the display device. The memory stores reference data used to prepare a reference image to be displayed by the display device. The preparation unit prepares output image data including the reference image using the device information acquired by the acquisition unit and the reference data read from the memory to output the output image data to the display device.

### CROSS-REFERENCE TO RELATED APPLICATIONS

This application is based on and claims priority under 35 USC 119 from Japanese Patent Application No. 2013-015573 filed Jan. 30, 2013.

### BACKGROUND

### Technical Field

The present invention relates to an image processing apparatus and an image display system.

### SUMMARY

According to an aspect of the present invention, there is provided an image processing apparatus including: an acquisition unit that acquires, from a display device that displays an image on a display screen, device information peculiar to the display device; a memory that stores reference data used to prepare a reference image to be displayed by the display device; and a preparation unit that prepares output image data including the reference image using the device information acquired by the acquisition unit and the reference data read from the memory to output the output image data to the display device.

### BRIEF DESCRIPTION OF THE DRAWINGS

An exemplary embodiment of the present invention will be described in detail based on the following figures, wherein:

FIG. 1 illustrates an example of the configuration of an image display system according to an exemplary embodiment;

FIG. 2 illustrates a state in which a color setting system is attached to the image display system;

FIG. 3 is a flowchart illustrating the flow of a process performed by an image processing apparatus during operation to display a display image performed by the image display system;

FIG. 4 is a flowchart illustrating the flow of a process performed by the image processing apparatus during operation to prepare a color conversion table performed by the image display system and the color setting system;

FIG. 5 is a flowchart illustrating the procedures for preparing output image data for color measurement;

FIGS. 6A to 6C illustrate examples of a subject region-decision table used to decide a subject region for displaying a color-measurement image;

FIGS. 7A to 7C illustrate examples of the decided subject region;

FIGS. 8A to 8C illustrate other examples of the decided subject region;

FIG. 9 illustrates an example of a number-of-images decision table used to decide the color, number, and order of color-measurement images;

FIGS. 10A and 10B illustrate examples of the arrangement of the color-measurement images to be displayed on a display screen; and

FIGS. 11A and 11B illustrate the content of an image to be displayed by the image display system.

### DETAILED DESCRIPTION

An exemplary embodiment of the present invention will be described in detail below with reference to the accompanying drawings.

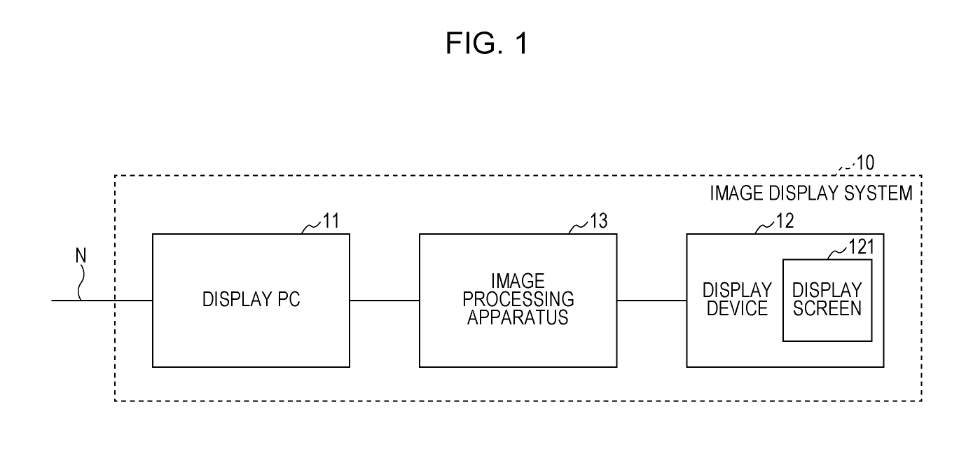

FIG. 1 illustrates an example of the configuration of an image display system 10 according to an exemplary embodiment.

The image display system 10 is connected to a network N, and includes a display personal computer (PC) 11, a display device 12, and an image processing apparatus 13. The display PC 11 prepares image data (input image data) for display, for example. The display device 12 causes an image to be displayed on a display screen 121. The image processing apparatus 13 performs a color conversion process on the input image data input from the display PC 11 using a color conversion table, and outputs obtained image data (output image data for display) to the display device 12. The image display system 10 is connected to other image display systems, various types of printers, and so forth via the network N.

In the image display system 10, the display PC 11 and the image processing apparatus 13 are connected to each other via a Digital Visual Interface (DVI), and the image processing apparatus 13 and the display device 12 are also connected to each other via a DVI. The components may be connected via a High-Definition Multimedia Interface (HDMI) or a DisplayPort in place of the DVI.

The display PC 11, which serves as an example of the supply device, may be a so-called general-purpose personal computer. The display PC 11 is adapted to cause various types of application software to operate under the management by an operating system (OS) to prepare input image data, for example.

The display device 12 may be a liquid crystal display for a PC, a liquid crystal television, or a projector, for example, which is configurated to provide a function of displaying an image through additive color mixing. Thus, the display device 12 may adopt a display method other than the liquid crystal method. In the example illustrated in FIG. 1, a display screen 121 is provided in the display device 12. However, in the case where the display device 12 is a projector, for example, the display screen 121 may be a screen or the like provided external to the display device 12.

The image processing apparatus 13, which serves as an example of the color conversion device, provides not only a function of performing the color conversion process discussed above but also a function of assisting the preparation of a color conversion table to be used in the color conversion process. More specifically, the image processing apparatus 13 provides a function of preparing image data (output image data for color measurement) that serves as the original of color-measurement images as an example of the reference image to be displayed on the display screen 121 of the display device 12 in the process of preparing a color conversion table. In the example, the image processing apparatus 13 is placed outside the management of the OS of the display PC 11, and adapted to be not restricted in terms of function by the OS of the display PC 11. The image processing apparatus 13 will be discussed in detail later.

In the image display system 10 illustrated in FIG. 1, one display device 12 is connected to one display PC 11 via one image processing apparatus 13. However, the present invention is not limited to such a configuration. For example, plural display devices 12 may be connected to one image processing apparatus 13 to form a so-called multi-monitor configuration in which the display devices 12 display continuous different images. Alternatively, plural image processing apparatuses 13 may be connected to one display PC 11 and respective display devices 12 may be connected to the image processing apparatuses 13 to form a multi-monitor configuration.

In the image display system 10 according to the exemplary embodiment, not the display PC 11 but the image processing apparatus 13 performs a color conversion process on the input image data to prepare output image data for display. The color conversion table used in the color conversion process performed by the image processing apparatus 13 has been prepared in consideration of the device characteristics of the display device 12 and the device characteristics of the other image display systems, printers, and so forth connected via the network N so as to match a color representation on the image display system 10 illustrated in FIG. 1 and a color representation on the other image display systems, printers, and so forth. Alternatively, the color conversion table has been prepared so as to match a color representation on the image display system 10 with a color representation with display device characteristics used as a de facto standard (such as sRGB and Adobe RGB (1998)). Such data may not necessarily be obtained via the network N, and may be stored in advance in the display PC 11 or acquired via a Universal Serial Bus (USB) or the like. In the image display system 10, a color conversion table is prepared in consideration of the device characteristics of the display device 12 with a color setting system to be discussed later externally attached to the image display system 10.

The color setting system attached to the image display system 10 in preparation of the color conversion table used by the image processing apparatus 13 will be illustrated.

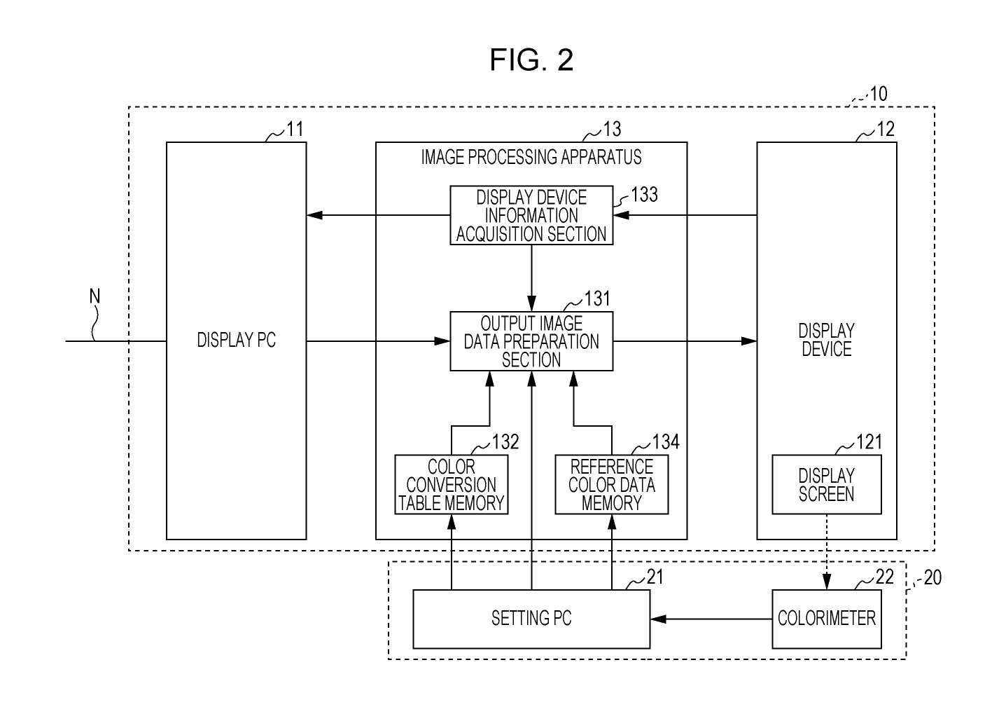

FIG. 2 illustrates a state in which a color setting system 20 is attached to the image display system 10 illustrated in FIG. 1. The internal configuration of the image processing apparatus 13 provided to the image display system 10 is also illustrated in FIG. 2.

The color setting system 20 according to the exemplary embodiment includes a setting PC 21 and a colorimeter 22. The setting PC 21 is connected to the image processing apparatus 13 of the image display system 10. The colorimeter 22 is connected to the setting PC 21, and measures the color of an image displayed on the display screen 121 of the display device 12 of the image display system 10.

In the color setting system 20, the setting PC 21 and the colorimeter 22 are connected to each other via a USB or an RS-232C. The setting PC 21 of the color setting system 20 and the image processing apparatus 13 of the image display system 10 are connected to each other via a USB.

In the color setting system 20, the setting PC 21 may be a so-called general-purpose personal computer, and may be a laptop PC which is conveniently portable, for example. The setting PC 21 is also adapted to cause various types of application software to operate under the management by an OS.

The colorimeter 22 includes a sensor disposed in contact with or in no contact with the display screen 121 provided to the display device 12 of the image display system 10 to measure the color of an image displayed on the display screen 121. In the example, the size of a region to be measured by the sensor provided to the colorimeter 22 is set to be equal to or less than the size of the display screen 121. The colorimeter 22 is configurated not to measure the color for the entire region of the display screen 121, but to measure the color for a predetermined part of the entire region of the display screen 121.

In the color setting system 20 illustrated in FIG. 2, one colorimeter 22 is connected to one setting PC 21. However, the present invention is not limited to such a configuration. For example, plural colorimeters 22 may be connected to one setting PC 21. In FIG. 2, the setting PC 21 and the display PC 11 are illustrated as separate components. However, the setting PC 21 and the display PC 11 may be used as a common component.

In the color setting system 20 according to the exemplary embodiment, the setting PC 21 is adapted to acquire color-measurement device information peculiar to the colorimeter 22. Examples of the color-measurement device information include the manufacturer name, the model number, the number of pixels of the sensor (vertical×horizontal), the size of the region for which the color is measured by the sensor, and the position of attachment of the colorimeter 22 to the display screen 121 (measurement position). The setting PC 21 is adapted to output the acquired color-measurement device information to the image processing apparatus 13 of the image display system 10.

Next, the configuration of the image processing apparatus 13 provided to the image display system 10 will be described.

The image processing apparatus 13 according to the exemplary embodiment includes an output image data preparation section 131, a color conversion table memory 132, a display device information acquisition section 133, and a reference color data memory 134. The output image data preparation section 131 serves as an example of the preparation unit. The color conversion table memory 132 serves as an example of the memory. The display device information acquisition section 133 serves as an example of the acquisition unit. The reference color data memory 134 serves as an example of the memory.

The output image data preparation section 131 performs a color conversion on the input image data input from the display PC 11 using a color conversion table read from the color conversion table memory 132, and outputs obtained output image data for display to the display device 12. In addition, the output image data preparation section 131 prepares output image data for color measurement on the basis of the display device information acquired by the display device information acquisition section 133, the color-measurement device information acquired from the setting PC 21, and reference color data, which serve as an example of the reference data, read from the reference color data memory 134 when the color conversion table stored in the color conversion table memory 132 is prepared or updated, and outputs the prepared data to the display device 12.

The color conversion table memory 132 stores a color conversion table used in the preparation of output image data for display performed by the output image data preparation section 131 discussed above. Examples of the color conversion table include a matrix for conversion, a one-dimensional look-up table (LUT), and a multi-dimensional LUT. The color conversion table memory 132 may be a non-volatile memory (e.g. a flash memory) that is readable and writable and that is capable of holding the memory content even if no power is supplied.

The display device information acquisition section 133 acquires display device information peculiar to the display device 12 from the display device 12. Examples of the display device information, which serves as an example of the device information, include the manufacturer name, the model number, the number of pixels of the sensor (vertical×horizontal), the screen size (in inches), and the type (such as a PC display, a television, and a projector). Extended Display Identification Data (EDID) may be utilized as an example of the display device information. In the example, the display device information acquisition section 133 is adapted to output the acquired display device information also to the display PC 11. This enables plug and play between the display PC 11 and the display device 12 connected via the image processing apparatus 13 (enables the display PC 11 to grasp the display device information on the display device 12) as in the case where the display PC 11 and the display device 12 are directly connected to each other.

The reference color data memory 134 stores reference color data used in the preparation of output image data for color measurement performed by the output image data preparation section 131 discussed above. The reference color data include plural data with different colors represented in the CIELAB color space which does not depend on the device, for example. The reference color data memory 134 may be a non-volatile memory (e.g. a flash memory) that is readable and writable and that is capable of holding the memory content even if no power is supplied.

In the exemplary embodiment, the setting PC 21 provided to the color setting system 20 is capable of writing a color conversion table into the color conversion table memory 132 provided to the image processing apparatus 13 of the image display system 10. In addition, the setting PC 21 provided to the color setting system 20 is capable of writing reference color data into the reference color data memory 134 provided to the image processing apparatus 13 of the image display system 10.

Normally, the image display system 10 according to the exemplary embodiment displays, on the display screen 121 of the display device 12, an image (display image) based on output image data for display obtained by the image processing apparatus 13 by performing a color conversion on the input image data prepared by the display PC 11 with the color setting system 20 not attached to the image display system 10. When the color conversion table is prepared, updated, or the like, on the other hand, the image display system 10 displays, on the display screen 121 of the display device 12, an image (color-measurement image) based on output image data for color measurement prepared by the image processing apparatus 13 with the color setting system 20 attached to the image display system 10.

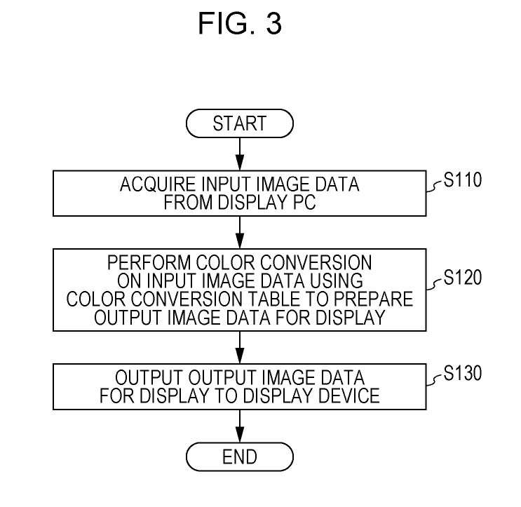

FIG. 3 is a flowchart illustrating the flow of a process performed by the image processing apparatus 13 during operation to display a display image performed by the image display system 10.

In the process, first, the output image data preparation section 131 acquires input image data from the display PC 11 (step S110).

Next, the output image data preparation section 131 performs a color conversion on the input image data acquired in step S110 using a color conversion table read from the color conversion table memory 132 to prepare output image data for display (step S120).

The output image data preparation section 131 outputs the output image data for display prepared in step S120 to the display device 12 (step S130), and completes the sequence of processes. After step S130, a display image based on the output image data for display is displayed on the display screen 121 of the display device 12.

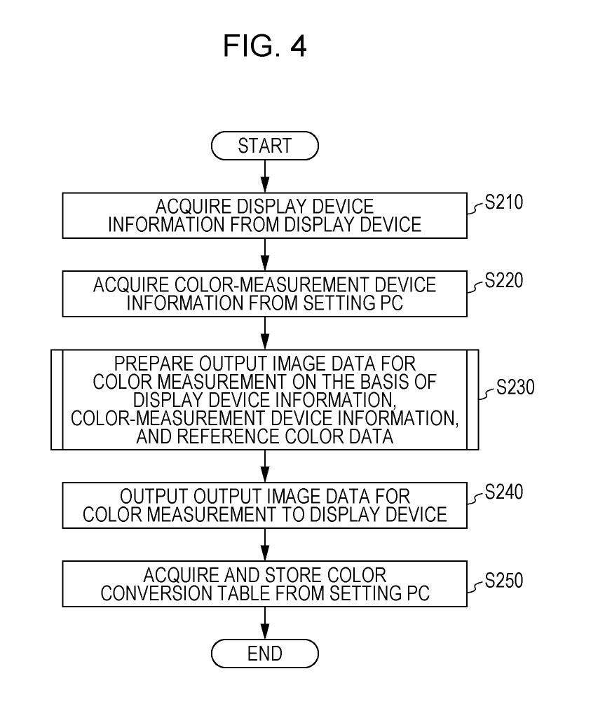

FIG. 4 is a flowchart illustrating the flow of a process performed by the image processing apparatus 13 during operation to prepare a color conversion table performed by the image display system 10 and the color setting system 20.

In the process, first, the display device information acquisition section 133 acquires display device information from the display device 12 (step S210). In addition, the output image data preparation section 131 acquires color-measurement device information from the setting PC 21 (step S220). The order of step S210 and step S220 may be reversed.

Next, the output image data preparation section 131 prepares output image data for color measurement on the basis of the display device information acquired by the display device information acquisition section 133 in step S210, the color-measurement device information acquired in step S220, and reference color data acquired from the reference color data memory 134 (step S230). Step S230 will be discussed in detail later.

The output image data preparation section 131 outputs the output image data for color measurement prepared in step S230 to the display device 12 (step S240). After step S240, a color-measurement image based on the output image data for color measurement is displayed on the display screen 121 of the display device 12. The color of the color-measurement image is measured by the colorimeter 22. Further, in the setting PC 21, a color conversion table is prepared on the basis of the results of the color measurement performed by the colorimeter 22, and output to the image processing apparatus 13.

After that, the color conversion table memory 132 acquires and stores the color conversion table sent from the setting PC 21 (step S250), and completes the sequence of processes.

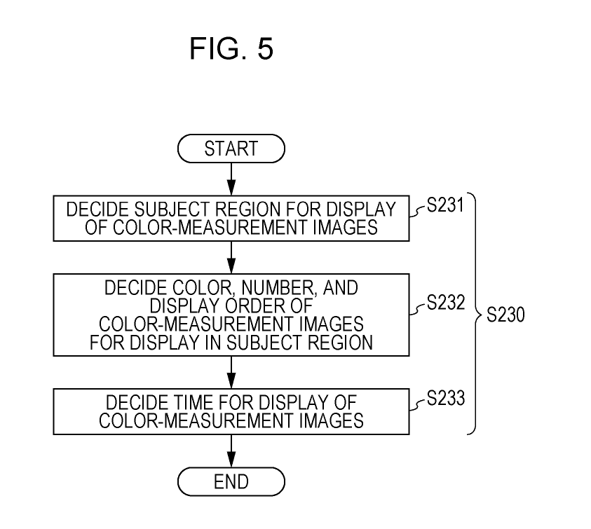

FIG. 5 is a flowchart illustrating step S230 illustrated in FIG. 4, that is, the procedures for preparing output image data for color measurement performed by the image processing apparatus 13.

In the process, first, a subject region for display of color-measurement images on the display screen 121 of the display device 12 is decided on the basis of the display device information and the color-measurement device information (step S231).

Subsequently, the color, number, and display order of the color-measurement images for display in the subject region decided in step S231 are decided on the basis of the display device information, the color-measurement device information, and the reference color data (step S232).

The time for display of the color-measurement images decided in step S232 is decided (step S233) to obtain output image data for color measurement.

Thus, in the operation to prepare a color conversion table, the display device 12 and the image processing apparatus 13 provided to the image display system 10 and the setting PC 21 and the colorimeter 22 provided to the color setting system 20 are used, and the display PC 11 provided to the image display system 10 is not used. That is, the display PC 11 is not necessary in the operation to prepare a color conversion table. In the operation to prepare a color conversion table, in addition, the output image data preparation section 131 provided to the image processing apparatus 13 of the image display system 10 does not perform a color conversion process using a color conversion table read from the color conversion table memory 132.

Next, preparation of the output image data for color measurement discussed above will be described with reference to a specific example.

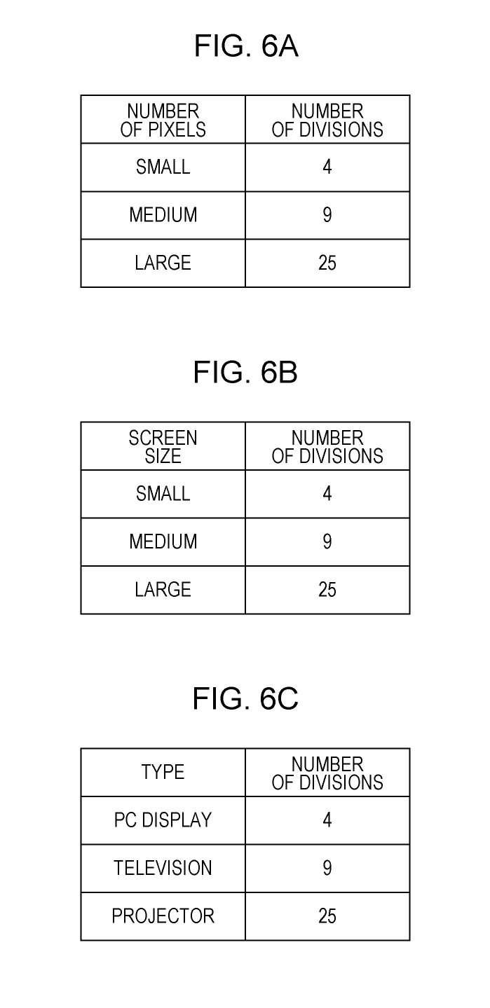

FIGS. 6A to 6C illustrate examples of a subject region-decision table used to decide a subject region for displaying a color-measurement image (step S231 illustrated in FIG. 5). The subject region-decision table is stored in the non-volatile memory provided to the output image data preparation section 131, for example. FIGS. 6A to 6C illustrate subject region-decision tables used in the case where one display device 12 is connected to one image processing apparatus 13. FIG. 6A illustrates a subject region-decision table in which the number of pixels of the display device 12, which serves as an example of the display device information, and the number of divisions of the display screen 121 are correlated with each other. FIG. 6B illustrates a subject region-decision table in which the screen size of the display device 12, which serves as an example of the display device information, and the number of divisions of the display screen 121 are correlated with each other. FIG. 6C illustrates a subject region-decision table in which the type of the display device 12, which serves as an example of the display device information, and the number of divisions of the display screen 121 are correlated with each other.

In the example illustrated in FIG. 6A, for example, the display screen 121 is divided into four divisions in the case where the number of pixels of the display device 12 is relatively small (indicated as “SMALL” in the drawing). The display screen 121 is divided into 25 divisions in the case where the number of pixels of the display device 12 is relatively large (indicated as “LARGE” in the drawing). The display screen 121 is divided into nine divisions in the case where the relative number of pixels of the display device 12 falls between “SMALL” and “LARGE” described above (indicated as “MEDIUM” in the drawing).

In the example illustrated in FIG. 6B, for example, the display screen 121 is divided into four divisions in the case where the screen size of the display device 12 is relatively small (indicated as “SMALL” in the drawing). The display screen 121 is divided into 25 divisions in the case where the screen size of the display device 12 is relatively large (indicated as “LARGE” in the drawing). The display screen 121 is divided into nine divisions in the case where the screen size of the display device 12 falls between “SMALL” and “LARGE” described above (indicated as “MEDIUM” in the drawing).

In the example illustrated in FIG. 6C, for example, the display screen 121 is divided into four divisions in the case where the display device 12 is a “PC DISPLAY”. The display screen 121 is divided into nine divisions in the case where the display device 12 is a “TELEVISION”. The display screen 121 is divided into 25 divisions in the case where the display device 12 is a “PROJECTOR”.

The display screen 121 is divided in units of pixels of the display device 12.

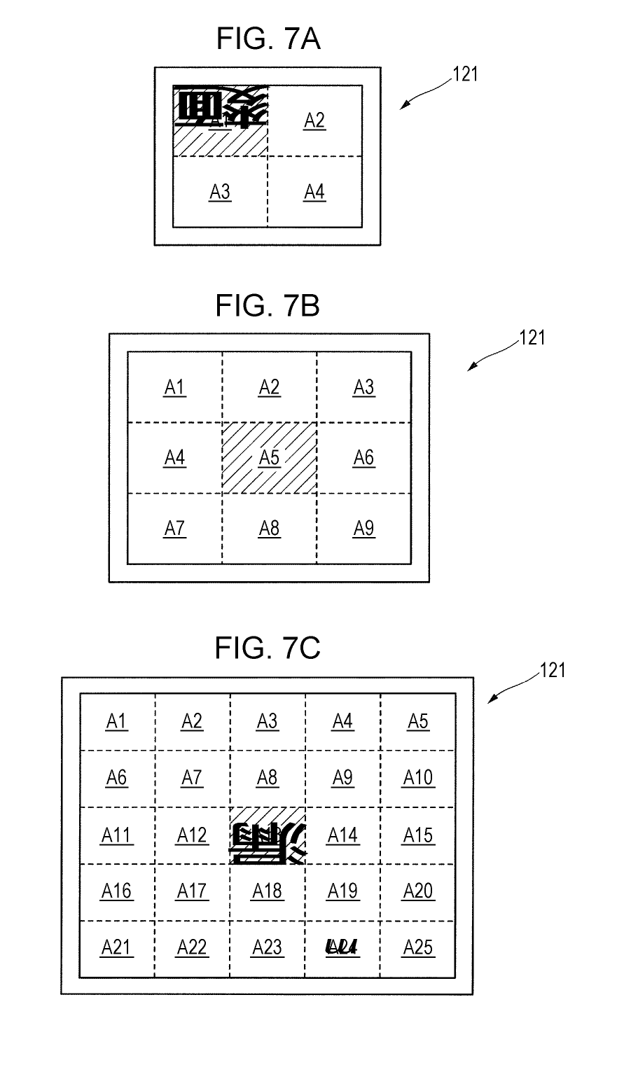

FIGS. 7A to 7C illustrate examples of the subject region decided in step S231 illustrated in FIG. 5. FIG. 7A illustrates a case where the display screen 121 is divided into four divisions. FIG. 7B illustrates a case where the display screen 121 is divided into nine divisions. FIG. 7C illustrates a case where the display screen 121 is divided into 25 divisions. FIG. 7A corresponds to a case where the number of pixels of the display device 12 is “SMALL” in FIG. 6A, a case where the screen size of the display device 12 is “SMALL” in FIG. 6B, and a case where the display device 12 is a “PC DISPLAY” in FIG. 6C. FIG. 7B corresponds to a case where the number of pixels of the display device 12 is “MEDIUM” in FIG. 6A, a case where the screen size of the display device 12 is “MEDIUM” in FIG. 6B, and a case where the display device 12 is a “TELEVISION” in FIG. 6C. FIG. 7C corresponds to a case where the number of pixels of the display device 12 is “LARGE” in FIG. 6A, a case where the screen size of the display device 12 is “LARGE” in FIG. 6B, and a case where the display device 12 is a “PROJECTOR” in FIG. 6C.

In FIG. 7A, for example, the display screen 121 is divided into four regions, namely a first region A1 to a fourth region A4. In the example illustrated in FIG. 7A, the first region A1 to the fourth region A4 are arranged in two vertical columns and two horizontal rows, and have substantially the same area (number of pixels) as each other. In the example, the first region A1 which is on the upper left side in the drawing is selected as a subject region for displaying a color-measurement image on the basis of the color-measurement device information.

In FIG. 7B, for example, the display screen 121 is divided into nine regions, namely a first region A1 to a ninth region A9. In the example illustrated in FIG. 7B, the first region A1 to the ninth region A9 are arranged in three vertical columns and three horizontal rows, and have substantially the same area (number of pixels) as each other. In the example, the fifth region A5 which is in the center in the drawing is selected as a subject region for displaying a color-measurement image on the basis of the color-measurement device information.

In FIG. 7C, for example, the display screen 121 is divided into 25 regions, namely a first region A1 to a twenty-fifth region A25. In the example illustrated in FIG. 7C, the first region A1 to the twenty-fifth region A25 are arranged in five vertical columns and five horizontal rows, and have substantially the same area (number of pixels) as each other. In the example, the thirteenth region A13 which is in the center in the drawing is selected as a subject region for displaying a color-measurement image on the basis of the color-measurement device information.

The first region A1, the fifth region A5, and the thirteenth region A13 are selected as a subject region in the example illustrated in FIG. 7A, the example illustrated in FIG. 7B, and the example illustrated in FIG. 7C, respectively. However, the present invention is not limited thereto, and the subject region may be changed in accordance with which region of the display screen 121 of the display device 12 is to be measured by the colorimeter 22 (an example of the color-measurement device information). That is, FIG. 7A illustrates a case where the colorimeter 22 measures the first region A1 of the display screen 121. FIG. 7B illustrates a case where the colorimeter 22 measures the fifth region A5 of the display screen 121. FIG. 7C illustrates a case where the colorimeter 22 measures the thirteenth region A13 of the display screen 121.

Next, a case where the subject region is set in accordance with the number of display devices 12 connected to one image processing apparatus 13 will be described.

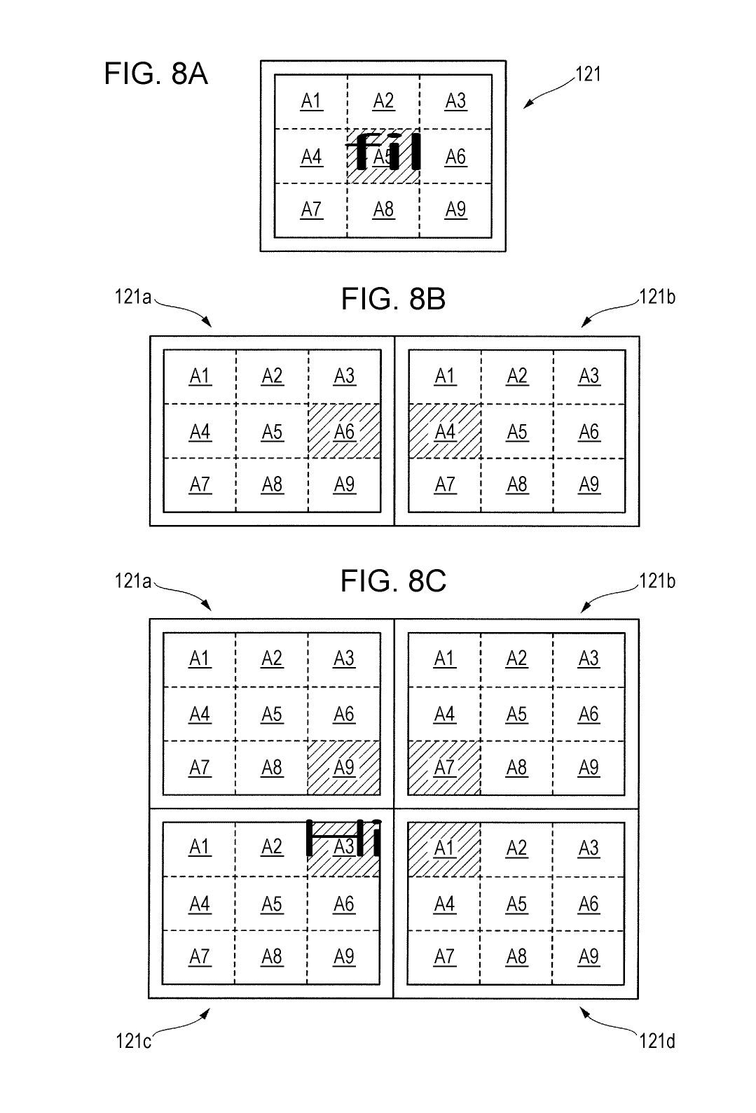

FIGS. 8A to 8C illustrate other examples of the subject region decided in step S231 illustrated in FIG. 5. FIG. 8A illustrates a case where one display device 12 is connected to one image processing apparatus 13. FIG. 8B illustrates a case where two display devices 12 are connected to one image processing apparatus 13. FIG. 8C illustrates a case where four display devices 12 are connected to one image processing apparatus 13. In the example illustrated in FIG. 8B, the two display devices 12 are arranged in a horizontal row such that a first display screen 121a is continuous with a second display screen 121b in the horizontal direction. In the example illustrated in FIG. 8C, the four display devices 12 are arranged in two vertical columns and two horizontal rows such that a first display screen 121a and a third display screen 121c are continuous with a second display screen 121b and a fourth display screen 121d in the horizontal direction, respectively, and the first display screen 121a and the second display screen 121b are continuous with the third display screen 121c and the fourth display screen 121d in the vertical direction, respectively.

In the examples illustrated in FIGS. 8A to 8C, the display screens 121 (the first display screen 121a to the fourth display screen 121d) are each divided into nine regions (a first region A1 to a ninth region A9).

In the case of a single display screen 121 such as that illustrated in FIG. 8A, for example, the fifth region A5 which is in the center in the drawing is selected as a subject region for displaying a color-measurement image.

In contrast, in the case where the first display screen 121a and the second display screen 121b are arranged in a horizontal row as illustrated in FIG. 8B, for example, the sixth region A6, which is positioned on the right side in the horizontal direction and in the center in the vertical direction in the drawing, is selected as a subject region for displaying a color-measurement image in the first display screen 121a. In the second display screen 121b located adjacently on the right side of the first display screen 121a, the fourth region A4, which is positioned on the left side in the horizontal direction and in the center in the vertical direction in the drawing, is selected as a subject region for displaying a color-measurement image.

In the case where the first display screen 121a to the fourth display screen 121d are arranged in two vertical columns and two horizontal rows as illustrated in FIG. 8C, for example, the ninth region A9, which is positioned on the right side in the horizontal direction and on the lower side in the vertical direction in the drawing, is selected as a subject region for displaying a color-measurement image in the first display screen 121a. In the second display screen 121b located adjacently on the right side of the first display screen 121a, the seventh region A7, which is positioned on the left side in the horizontal direction and on the lower side in the vertical direction in the drawing, is selected as a subject region for displaying a color-measurement image. In the third display screen 121c positioned on the lower side of the first display screen 121a, the third region A3, which is positioned on the right side in the horizontal direction and on the upper side in the vertical direction in the drawing, is selected as a subject region for displaying a color-measurement image. In the fourth display screen 121d positioned on the lower side of the second display screen 121b and on the right side of the third display screen 121c, the first region A1, which is positioned on the left side in the horizontal direction and on the upper side in the vertical direction in the drawing, is selected as a subject region for displaying a color-measurement image.

In the case where a multi-monitor configuration such as those illustrated in FIGS. 8B and 8C is adopted, two adjacent regions are selected as subject regions from plural regions forming each of the two adjacent display screens 121.

In the examples illustrated in FIGS. 7A to 7C and 8A to 8C, one of plural regions obtained by dividing one display screen 121 is selected as a subject region. However, the present invention is not limited thereto. In the case where plural colorimeters 22 are provided to allow color measurement for plural regions in one display screen 121, for example, a number of regions, the number of which is the same as the number of regions for which color measurement is allowed, may be set as subject regions. For example, in the case where nine colorimeters 22 are provided to allow color measurement for nine regions (the first region A1 to the ninth region A9) in the display screen 121, the first region A1 to the ninth region A9 may be set as subject regions.

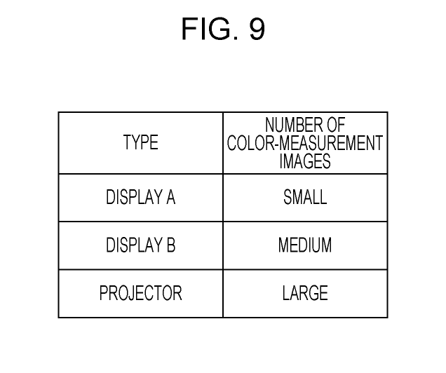

FIG. 9 illustrates an example of a number-of-images decision table used to decide the color, number, and order of color-measurement images to be displayed in the subject region (step S232 in FIG. 5). As with FIGS. 6A to 6C discussed above, FIG. 9 illustrates a number-of-images decision table used in the case where one display device 12 is connected to one image processing apparatus 13.

In the example illustrated in FIG. 9, the number of color-measurement images is made relatively small (indicated as “SMALL” in the drawing) in the case where a display manufactured by manufacturer A (indicated as “DISPLAY A” in the drawing) is used, for example. In the case where a projector is used, for example, the number of color-measurement images is made relatively large (indicated as “LARGE” in the drawing). In the case where a display manufactured by manufacturer B (indicated as “DISPLAY B” in the drawing) is used, for example, the number of color-measurement images is caused to fall between “SMALL” and “LARGE” described above (indicated as “MEDIUM” in the drawing). The number of colors of the reference color data stored in the reference color data memory 134 is set to be at least equal to or more than the number of color-measurement images for the projector.

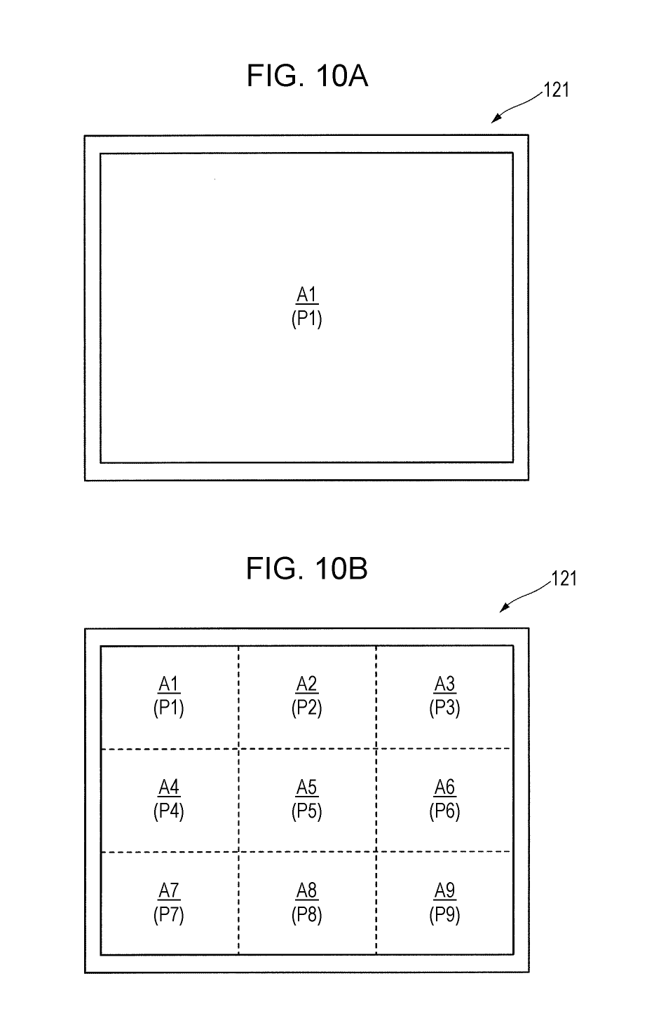

FIGS. 10A and 10B illustrate examples of the arrangement of the color-measurement images to be displayed on the display screen 121. FIG. 10A illustrates a case where one color-measurement image P1 is displayed in the first region A1 formed without dividing one display screen 121. In contrast, FIG. 10B illustrates a case where one display screen 121 is divided into nine regions (a first region A1 to a ninth region A9) and nine different color-measurement images P1 to P9 are displayed in the first region A1 to the ninth region A9, respectively. The example illustrated in FIG. 10A is applied to a case where only one colorimeter 22 is provided to perform measurement. In contrast, the example illustrated in FIG. 10B is applied to a case where plural (in the example, nine) colorimeters 22 are provided to perform measurement, or a colorimeter 22 capable of two-dimensional measurement (surface measurement) is connected.

Although the description given above is related to the preparation of output image data for color measurement during preparation of a color conversion table, the image processing apparatus 13 according to the embodiment further has other functions.

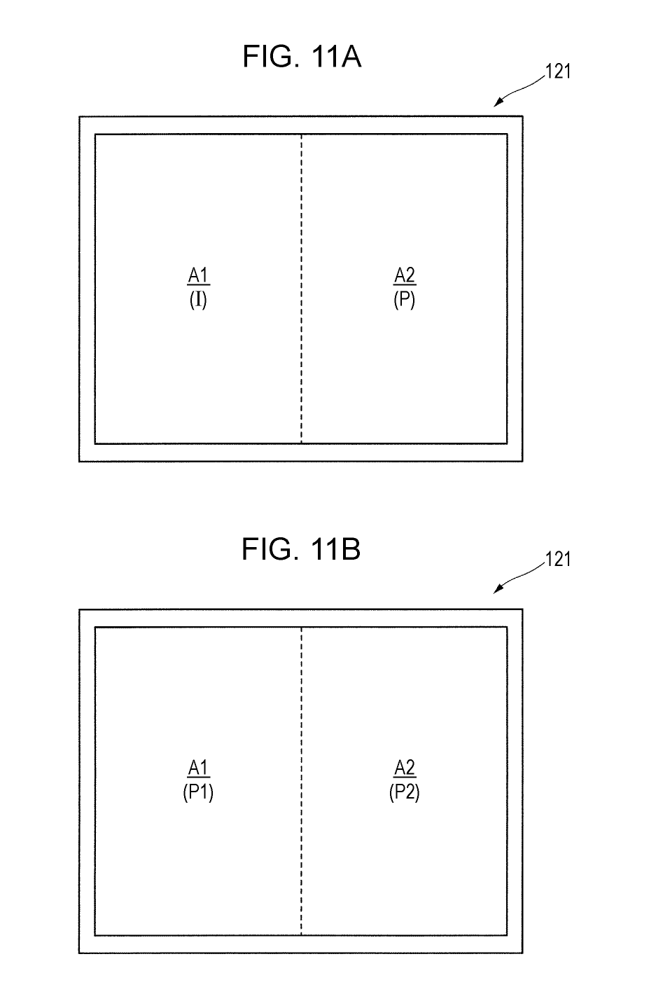

FIGS. 11A and 11B illustrate examples of other images that the image display system 10 according to the embodiment allows the display screen 121 of the display device 12 to display using the image processing apparatus 13.

In the example illustrated in FIG. 11A, for example, one display screen 121 is divided into two regions (a first region A1 and a second region A2). In the first region A1, a display image I based on output image data for display obtained by the output image data preparation section 131 by performing a color conversion process on input image data input from the display device 12 to the image processing apparatus 13 is displayed. In the second region A2 located adjacent to the first region A1, a color-measurement image P based on output image data for color measurement obtained by the output image data preparation section 131 by performing a color conversion process on specific reference color data read from the reference color data memory 134 is displayed.

Thus, the image processing apparatus 13 according to the exemplary embodiment is capable of preparing output image data on the basis of plural (in the example, two) image data obtained from different sources. In the image processing apparatus 13 according to the exemplary embodiment, in addition, the output image data preparation section 131 is also capable of performing a color conversion process on reference color data read from the reference color data memory 134 using a color conversion table read from the color conversion table memory 132 to output the resulting data.

In the example illustrated in FIG. 11B, for example, one display screen 121 is divided into two regions (a first region A1 and a second region A2). In the first region A1, a first color-measurement image P1 based on first output image data for color measurement obtained without the output image data preparation section 131 performing a color conversion process on specific reference color data read from the reference color data memory 134 is displayed. In the second region A2 located adjacent to the first region A1, a second color-measurement image P2 based on second output image data for color measurement obtained by the output image data preparation section 131 by performing a color conversion process on specific reference color data (reference color data for the same color) read from the reference color data memory 134 is displayed.

Thus, in the image processing apparatus 13 according to the exemplary embodiment, the output image data preparation section 131 is capable of outputting, collectively as one output image data, image data obtained by performing a color conversion process on reference color data read from the reference color data memory 124 using a color conversion table read from the color conversion table memory 132 and image data obtained by not performing a color conversion process on reference color data of the same content read from the reference color data memory 124.

In the image processing apparatus 13 according to the exemplary embodiment, the content of reference color data stored in the reference color data memory 134 is rewritable not by the display PC 11 but by the setting PC 21.

In the image display system 10 according to the exemplary embodiment, the image processing apparatus 13 which is separate from the display PC 11 and the display device 12 is disposed between the display PC 11 and the display device 12. However, the present invention is not limited thereto. For example, the functions of the image processing apparatus 13 may be implemented by the display device 12, or may be implemented by the display PC 11. It should be noted, however, that in the case where the functions of the image processing apparatus 13 are implemented by the display PC 11, it is necessary to implement the functions of the image processing apparatus 13 outside the management of the OS of the display PC 11, such as through a video card (graphics card), for example.

In the exemplary embodiment, the image processing apparatus 13 is provided to the image display system 10 illustrated in FIG. 1. However, in a configuration in which other image display systems or various types of printers are connected to the image display system 10 via the network N, for example, the image processing apparatus 13 is attached to each of the image display systems or the printers.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an acquisition unit that acquires, from a display device that displays an image on a display screen, device information peculiar to the display device;
a memory that stores reference data used to prepare a reference image to be displayed by the display device; and
a preparation unit that prepares output image data including the reference image using the device information acquired by the acquisition unit and the reference data read from the memory to output the output image data to the display device.

2. The image processing apparatus according to claim 1,
wherein the preparation unit prepares the output image data by setting a region for displaying the reference image in the display image on the basis of the device information.

3. The image processing apparatus according to claim 1,
wherein the memory stores a plurality of reference color data with different colors as the reference data, and
the preparation unit prepares the output image data using one or more reference color data selected from the plurality of reference color data on the basis of the device information.

4. The image processing apparatus according to claim 1,
wherein the preparation unit performs a color conversion process on input image data input from outside using a color conversion table, and outputs color-converted input image data obtained by performing the color conversion process to the display device as the output image data, and
the memory further stores the color conversion table.

5. The image processing apparatus according to claim 4,
wherein the preparation unit prepares the output image data by switching to and not to perform the color conversion process using the color conversion table.

6. The image processing apparatus according to claim 4,
wherein the preparation unit prepares the output image data including the input image data and the reference data.

7. The image processing apparatus according to claim 1,
wherein the reference data stored in the memory is rewritable by a computer device provided externally.

8. An image display system comprising:
a supply device that supplies input image data;
a color conversion device that performs a color conversion process on the input image data supplied from the supply device using a color conversion table and that outputs color-converted input image data obtained by performing the color conversion process as output image data; and
a display device that displays an image on a display screen on the basis of the output image data input from the color conversion device,
wherein the color conversion device includes
an acquisition unit that acquires device information peculiar to the display device from the display device,
a memory that stores reference data used to prepare a reference image to be displayed by the display device, and
a preparation unit that prepares output image data including the reference image using the device information acquired by the acquisition unit and the reference data read from the memory to output the output image data to the display device.
